(19) United States
(12) Patent Application Publication
(10) Pub. No.: US 2007/0186403 A1
(43) Pub. Date: Aug. 16, 2007

(54) Method For Applying Elastic Element To A Material Web

(75) Inventors: Christian Jarpenberg, Landvetter (SE); Kenneth Henriksson, Molndal (SE); Anders Norder, Lindome (SE)

Correspondence Address: BUCHANAN, INGERSOLL & ROONEY PC, POST OFFICE BOX 1404, ALEXANDRIA, VA, 22313-1404, US

(73) Assignee: SCA HYGIENE PRODUCTS AB, Goteborg (SE)

(21) Appl. No.: 11/738,472

(22) Filed: Apr. 21, 2007

Related U.S. Application Data
(63) Continuation of application No. 10/778,046, filed on Feb. 17, 2004.
(60) Provisional application No. 60/448,486, filed on Feb. 21, 2003.

(51) Int. Cl. B23P 11/02

(52) U.S. Cl. 29/450

(57) ABSTRACT

A method for applying elastic elements (1a, 1b, 1c) to a continuous material web (7) includes a first roll device (4, 5; 4, 5′) for advancing the elastic elements (1a, 1b, 1c) in series and at a first predetermined speed (v1) and a second roll device (6; 11, 12) for advancing the material web (7) at a second predetermined speed (v2). The second speed (v2) exceeds the first speed (v1) and the method includes an abutment surface (6; 10a) arranged at a distance (d) from the first roll device (4, 5; 4, 5′) which is less than the combined thickness of the elastic elements (1a, 1b, 1c) and the material web (7), an elongation of the elastic elements (1a, 1b, 1c) in their longitudinal direction being realized as they pass between the first roll device (4, 5; 4, 5′) and the said abutment surface (6; 10a).

### CROSS-REFERENCE TO RELATED APPLICATIONS

The present application is a continuation of U.S. Ser. No. 10/778,046, filed on Feb. 17, 2004, and claims the benefit of U.S. Provisional Application No. 60/448,486, filed in the United States on Feb. 21, 2003. The entire contents of both applications are hereby incorporated herein by reference.

### BACKGROUND OF THE APPLICATION

1. Technical Field

The present invention relates to a method for applying elastic elements to a continuous material web, comprising advancing the said elastic elements in series one after the other at a first predetermined speed and advancing the said material web at a second predetermined speed.

2. Related Art

In connection with absorbent products, such as, for example, nappies for infants, various types of elastic elements are used to lend the finished article suitable elasticity along, for example, its crutch section or waist section. Such elastic elements can be constituted, for example, by narrow strips having suitable elastic properties, which are then applied along the sides of the absorbent product. Application of elastic elements can also be utilized in other absorbent products such as, for example, incontinence pads for adults and sanitary towels.

According to the conventional art, elastic elements of the aforementioned type are applied to an absorbent product in such a way that they are first stretched somewhat and then attached to an underlying material web. This is expediently realized in this case by gluing or ultrasonic welding. After this, any additional material layers and components can be attached to the product, after which it is cut to a suitable length so that the finished article is formed. The elastic element will then create a suitable elasticity in the finished article.

An application of elastic elements can be realized intermittently, i.e., in such a way that individual elastic elements are applied in series one after the other to predetermined positions along the underlying material web. Alternatively, the application of elastic elements can be realized by attaching a continuous strip of suitable elastic material to the material web.

A previously known arrangement for applying elastic elements to absorbent products in the form of nappies is shown in patent document U.S. Pat. No. 4,239,578. This document describes a system for applying elastic elements in the form of strips between a top layer and a bottom layer, the top layer first being coated with glue. The system comprises a feed roll for the elastic elements, which is driven at a speed which is lower than the speed of advancement for the top and bottom layers. In this way, the elastic elements are stretched somewhat before they are applied. Following application of the elastic elements (and other material layers forming part of the product), the material layers pass through a cutting bay, whereupon they are cut into individual nappies.

Although the arrangement described in U.S. Pat. No. 4,239,578 has a satisfactory working, in principle, there is still a need for continued improvements in arrangements and methods for applying elastic elements to absorbent products. There is especially a requirement for intermittent application of elastic elements, which provides opportunity for producing absorbent products with low material consumption and, moreover, with an attractive appearance.

### OBJECTS AND SUMMARY

A principal object of the present invention is to provide an improved method in which the above wishes and requirements are met.

The above object is achieved with a method for applying elastic elements to a continuous material web, the method comprising advancing the elastic elements in series one after the other at a first predetermined speed to a nip formed between a first roll device and an abutment surface, wherein the abutment surface is arranged at a distance from the first roll device which is less than a combined thickness of the elastic elements and the material web, advancing the material web at a second predetermined speed to the nip, wherein the second speed exceeds the first speed, and attaching the elastic elements to the material web at the nip so as to elongate the elastic elements in their longitudinal direction as the elastic elements pass through the nip.

According to a first embodiment of the invention, an abutment surface is utilized which is defined by the peripheral surface of the said second roll device. In this embodiment, the elastic elements are fed against the underlying material web, which has first been provided with a glue by means of a gluing bay. When the respective elastic element meets the material web in the interspace defined by the distance between the first roll device and the second roll device, the elastic element will be applied to the material web as the elastic element is elongated.

According to a further embodiment, the first roll device can, in turn, comprise a mating roll and a gripping roll, whilst the second roll device is expediently constituted by a laminating roll.

According to a further embodiment of the invention, an abutment surface is utilized, which is defined by an active surface of an ultrasonic horn. In this embodiment no glue is utilized, but rather the elastic elements are fed against the underlying material web adjoining the ultrasonic horn. When the respective elastic element meets the material web in the interspace defined by the distance between the first roll device and the ultrasonic horn, the elastic element will be applied by ultrasonic welding to the material web as the elastic element is elongated.

According to a further embodiment of the invention, a two-step elongation of the elastic elements is provided. In this, a first roll device is utilized, which, in turn, comprises a mating roll and a gripping roll, the mating roll here being driven at a speed which is lower than the speed of the gripping roll.

### BRIEF DESCRIPTION OF THE FIGURES

The invention will be described below with reference to preferred embodiments and the appended figures, in which:

FIG. 1 shows a basic side view of an arrangement for applying elastic elements according to a first embodiment of the present invention,

FIG. 2 is a diagrammatic and somewhat simplified perspective view showing a material web with a number of applied elastic elements,

FIG. 3a shows in enlarged form a process for applying an elastic element, in a first step,

FIG. 3b shows in enlarged form a process for applying an elastic element, in a second step,

FIG. 4 shows a basic side view of an arrangement for applying elastic elements, according to a second embodiment of the invention, and

FIG. 5 shows in enlarged form a process for applying an elastic element according to the said second embodiment.

### DETAILED DESCRIPTION OF THE PREFERRED EMBODIMENTS

The present embodiment will now be described with reference to a preferred embodiment. As illustrated by FIG. 1, the invention, according to a first embodiment, is constituted by a method for applying elastic elements to an absorbent product. The invention can expediently be utilized in connection with production processes for absorbent products such as nappies, incontinence pads or sanitary towels.

As illustrated by FIG. 1, a continuous strip or web 1 of elastic material is provided. Preferably, this material is constituted by a relatively thin and ductile strip of polyurethane foam, but other materials are also conceivable, such as, for example, ductile synthetic materials which then can be provided in the form of bands, tapes or strips and which are unrolled successively from a reel 2 in connection with a production process for absorbent products. For the supply of elastic material, feed rolls (not shown) are expediently utilized, which, in a known manner, can be arranged for advancement of elastic material from the reel 2.

The elastic strip 1 is fed through two rolls, to be precise in the form of a cutting roll 3 and a mating roll 4, which are rotatably arranged. In a manner which is previously known per se, the cutting roll 3 is arranged to cut the elastic strip 1 into discrete and successive lengths. In FIG. 1, such separate elastic strips are denoted by the reference numerals 1a, 1b and 1c. The elastic strips 1a, 1b, 1c are given a length which is tailored to the size and the elastic properties of a desired elastic region on the finished absorbent product. During the feed process, the mating roll 4 rotates at a first, predetermined speed v1 along its periphery. Preferably, the cutting roll 3 has the same speed v1 as the mating roll 4, so that the cutting roll 3 cuts the elastic strip 1 at substantially the same point along the periphery of the mating roll 4 during its rotation.

Preferably, the mating roll 4 is configured in such a way that the respective elastic element 1a is securely retained during the rotation of the mating roll 4. This can be achieved by the mating roll 4 being configured with a vacuum device (not shown) and by its surface being provided with a number of through-openings (not shown), which allows a vacuum to be formed inside the mating roll 4. By means of the through-openings, this vacuum will act against the elastic element 1a running along the mating roll 4, so that this elastic element 1a can be securely held during the rotation.

As an alternative, or complement, to the aforementioned vacuum device, the peripheral surface of the mating roll 4 can be provided with a holding coating of a material having a high friction. In this way, the holding force which acts against the respective elastic element 1a advanced by means of the mating roll 4 is increased.

The arrangement according to the invention further comprises an additional roll in the form of a gripping roll 5, which is disposed directly adjoining the mating roll 4. Like the mating roll 4, the gripping roll 5 is also rotatably arranged and rotates, moreover, at substantially the same speed v1 as the mating roll 4, yet with the opposite rotational direction. Like the mating roll 4, the gripping roll 5 can also be provided with a vacuum apparatus and, where appropriate, also with a high-friction coating. In this way, the respective elastic element is fixed securely on the gripping roll 5 during its advancement. Expediently, the gripping roll 5 is arranged with a higher degree of retaining effect in its peripheral surface than the mating roll 4. Whilst the mating roll 4 can be permitted to have a somewhat lower friction force, which, in turn, allows a certain slippage of the elastic material when it is advanced by means of the mating roll 4, the gripping roll 5 has a higher friction and a higher retaining force acting against the respective elastic element 1a, 1b, 1c.

It can thus be established that the mating roll 4 and the gripping roll 5 together form a first roll device, which aims to advance elastic elements 1a, 1b, 1c at a predetermined, first speed v1.

Directly adjoining the gripping roll 5 there is another roll device in the form of a laminating roll 6. The laminating roll 6 rotates in the opposite direction to the gripping roll 5 and has a peripheral speed v2 which is higher than the corresponding speed v1 of the gripping roll 5. Preferably, the relationship between the two speeds v2, v1 is such that v2/v1=2, but the invention is not limited to just this speed ratio. The choice of suitable speed ratio v2/v1 depends, for example, on which elastic material is utilized and the desired elongation of the elastic material.

Between the gripping roll 5 and the laminating roll 6 is fed a material web 7, i.e., a continuous web of the material to which the elastic elements 1a, 1b, 1c are intended to be attached. Since the arrangement according to the invention is intended for use in the production of absorbent products, the underlying material web 7 is expediently constituted by a nonwoven material, which is intended to constitute a material layer in the finished article. The respective elastic element and the underlying material web 7 thus meet between the gripping roll 5 and the laminating roll 6. The elastic elements 1a, 1b, 1c can then be attached to the material web 7, by virtue of the material web 7 having been coated with a suitable glue before being fed past the gripping roll 5. This is allowed, in turn, by means of a gluing bay 8, which is then arranged up at a suitable point along the material web 7, to be precise before it meets the elastic elements 1a, 1b, 1c. The gluing is realized in a suitable pattern, for example in the form of a strand of glue, the placement of which is synchronized with the position of the respective elastic element 1a, 1b, 1c.

To enable the elastic elements 1a, 1b, 1c to be attached to the material web 7, the laminating roll 6 is arranged at a distance d from the gripping roll 5 which is less than the combined thickness of the said elastic elements and the material web. The said elastic elements and the material web 7 can thereby be squeezed together, as a result of the laminating roll 6 forming an abutment surface where the respective elastic element and the material web 7 meet.

As a result of the speed difference which exists between the gripping roll 5 and the laminating roll 6 and by virtue of a suitably chosen distance d between the gripping roll 5 and the laminating roll, an elongation is obtained in the material of the respective elastic element 1a, 1b, 1c when it is applied and passes between the gripping roll 5 and the laminating roll 6. This elongation interacts with the effect of the applied glue in such a way that the elastic elements are applied and fixed to the material web 7 in their elongated state. The invention is thus based on the principle that the speed v2 of the laminating roll 6 exceeds the speed v1 of the gripping roll 5. In this way, the elastic material is elongated at the same time as it is advanced and adheres to the glue on the material web 7. A further important feature of the invention relates to the fact that the distance d between the abutment surface formed by the laminating roll 6 and the point on the grip roll 5 at which the respective elastic element 1a, 1b, 1c meets the material web 7 and is glued in place is chosen such that a desired clamping of the respective elastic element against the material web 7 is obtained, which, in turn, gives good adhesion. The choice of the distance d is in this case matched to the dimensions and the remaining properties of the elastic elements 1a, 1b, 1c and the underlying material web 7, to the glue which is used in the gluing bay 8 and to the difference in speed between the laminating roll 6 and the gripping roll 5. In normal cases, the distance d can be chosen to the order of magnitude of 0.1-1 mm, but other measurements can also be used within the scope of the invention. By appropriate matching of various inherent parameters and dimensions, an elongation of the respective elastic element 1a, 1b, 1c is obtained, which can amount to 100% of its normal length. In certain cases, still greater degrees of elongation can be achieved, to be precise up to about 300% of the normal, unstretched length of the respective elastic element. The elongation which is enabled then depends, for example, on the elasticity of the included materials.

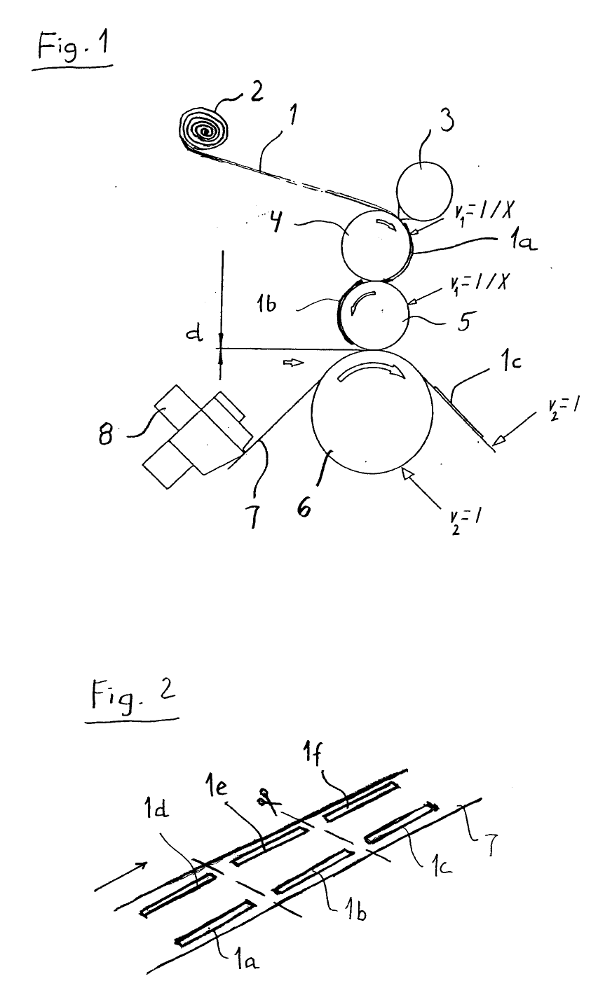

In FIG. 2 is shown an example of how a number of elastic elements 1a, 1b, 1c, 1d, 1e, 1f 265 can be applied to a material web 7. According to the side view shown in FIG. 1, it can be seen how a single longitudinal row of elastic elements 1a, 1b, 1c is applied to the material web 7. The invention can, however, be utilized such that a plurality of strips of elastic elements are advanced side by side so that they run substantially parallel and are applied to a material web 7, as is shown in FIG. 2. After the elastic elements 1a, 1b, 1c, 1d, 1e, 1f have been applied, any further material layers and components can be attached, so that a longitudinal continuous web is formed. This web is subsequently cut into separate absorbent articles by means of a crosscutting device (not shown). This is indicated symbolically by dashed lines in FIG. 2.

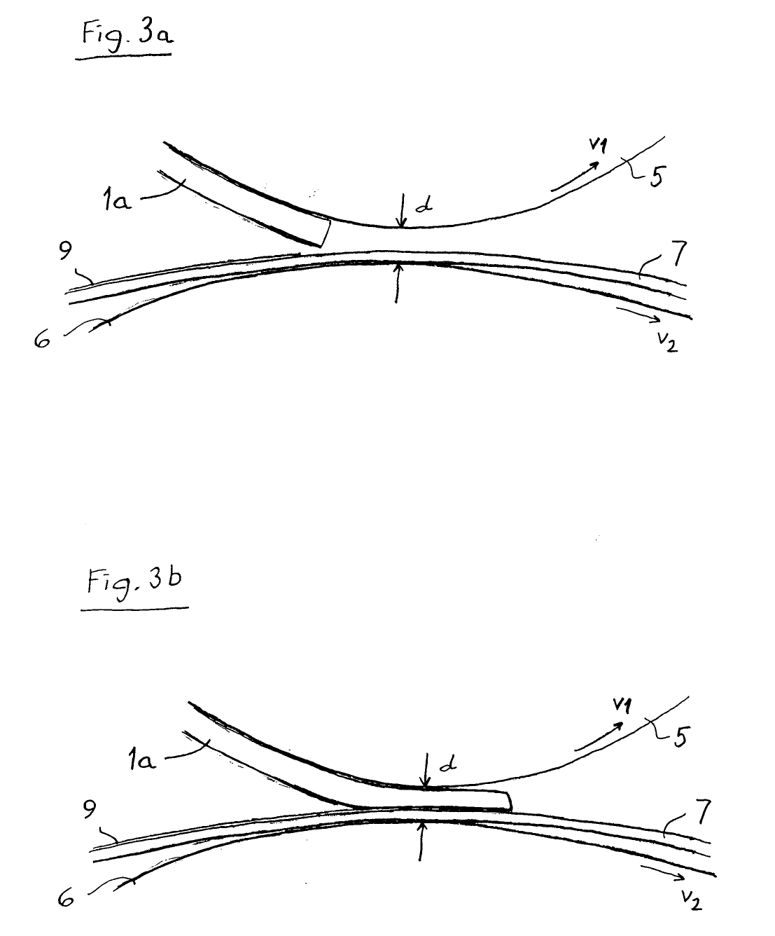

FIGS. 3a and 3b illustrate on an enlarged scale how an elastic element 1a is applied to a material web 7 according to the invention. FIGS. 3a and 3b correspond to the embodiment apparent from FIG. 1 and FIG. 2. It is assumed, as stated above, that the distance d between the gripping roll 5 and the abutment surface defined by the laminating roll 6 is less than the total thickness of the elastic element 1a and the material web 7 in their non-worked state. When the elastic element 1a is fed in to where the gripping roll 5 is closest to the laminating roll 6, the front end section of the elastic element 1a will be compressed. Since, moreover, the speed v2 of the laminating roll 6 is higher, furthermore, than the speed v1 of the gripping roll 5, an elongation of the elastic element 1a is obtained, moreover, in its longitudinal direction. This is apparent from FIG. 3b, in connection with which it should also be noted that the elastic element 1a is fixed to the material web 7 as a result of the prior application of a certain quantity of glue 9 to the material web 7.

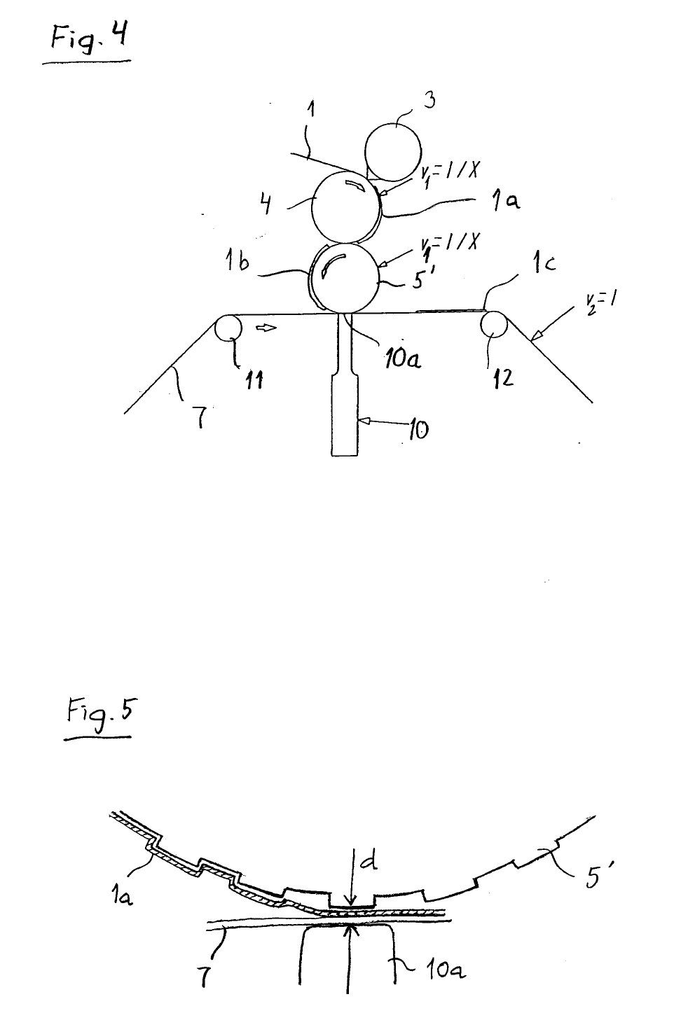

An alternative embodiment of the invention is shown in FIG. 4. This embodiment corresponds in large parts to the above description with reference to FIG. 1, but is based on the fact that elastic elements 1a, 1b, 1c and an underlying material web 7 are joined together by ultrasonic welding instead of by gluing. To this end, an ultrasonic horn 10 is disposed at the point where the respective elastic element 1a, 1b, 1c meets the material web 7. Ultrasonic welding is a technique which is previously known per se and which, according to the invention, can be utilized to join together the respective elastic elements 1a, 1b, 1c to the material web 7. Otherwise, the system according to FIG. 4 comprises a cutting roll 3 and a mating roll 4 with configuration and function corresponding to the above-stated with reference to FIG. 1. The system further comprises a second gripping roll 5′, which substantially corresponds to the gripping roll according to FIG. 1 but which is configured with a relief-like pattern in its peripheral surface. This pattern here constitutes a weld pattern when the material web 7 is laminated and ultrasonically welded to the respective elastic element. This stage is realized by the material web 7 being fed over two feed rolls 11, 12 so that it passes the ultrasonic horn 10. This feed is realized in such a way that the material web 7 is fed at a speed v2 which exceeds the speed v1 of the second gripping roll 5′. As previously explained, and since the upper, active surface 10a of the ultrasonic horn 10 forms an abutment surface, the respective elastic element will be applied to the material web in its elongated state. Expediently, no glue is used in this embodiment.

FIG. 5 illustrates on an enlarged scale how an elastic element 1a is applied to a material web 7 according to the embodiment apparent from FIG. 4. Here too, the distance d between the gripping roll 5′ and the abutment surface 9a defined by the ultrasonic horn 9 is less than the total thickness of the elastic element 1a and the material web 7 in their unworked state. In normal applications, the distance d is significantly smaller in the embodiment based on ultrasonic welding than where the application method is based on gluing (see FIG. 1). It can also be noted that the surface of the gripping roll 5′, as has been stated above, expediently has a relief-like pattern in order to allow ultrasonic welding. The gripping roll 5′ has the peripheral speed v1, whilst the material web 7 has the speed v2, the latter speed being obtained by advancement using two feed rolls 11, 12 (see FIG. 4). When the elastic element 1a is fed in to where the gripping roll 5′ is closest to the abutment surface 9a, the elastic element 1a will be stretched and elongated somewhat. By analogy with what has been explained above, the obtained elongation is based on the speed v2 of the material web 7 being higher than the speed v1 of the gripping roll 5′ as the elastic element 1a is applied.

The embodiment shown in FIGS. 4 and 5 comprises a stationary ultrasonic horn. A rotary ultrasonic horn can also be utilized within the scope of the invention. A rotary ultrasonic horn of this kind is previously known per se and is not here described in detail. It can be mentioned, however, that a rotary ultrasonic horn must in that case be disposed beneath the aforementioned material web 7 in a position substantially corresponding to the position of the stationary ultrasonic horn 10 according to FIG. 4.

According to a further embodiment of the invention, the elongation of the respective elastic element is realized in two separate steps. According to this embodiment, the mating roll 4 (see, for example, FIG. 1) is driven at a peripheral speed v3 which is lower than the speed v1 of the gripping roll 5, so that an initial stretching of the respective elastic element is realized even before it has been advanced to the material web 7. This is followed by a further step involving continued elongation of the elastic element at the transition from the gripping roll 5 to the laminating roll 6 by virtue of the speed v2 of the laminating roll 6, as has previously been stated, exceeding the speed v1 of the gripping roll 5. By this process, a higher degree of elongation of the elastic elements is enabled than has been described above with reference to FIG. 1. The principle of elongation which is realized in two separate can also be applied in the system shown in FIG. 3. This is here realized by the second gripping roll 5′ being given a peripheral speed v1 which exceeds the speed v3 of the mating roll 4. In this embodiment also, an opportunity is here given for a higher degree of elongation of the respective elastic element 1a, 1b, 1c.

The invention produces a method for applying elastic elements, which have a simple structure and which allow effective production of absorbent products, in which material consumption can be limited. Moreover, an attractive appearance is obtained of the finished articles produced according to the invention.

According to a further embodiment of the invention, the gripping roll can be omitted. If the mating roll is provided with a surface having a suitably matched friction, in which case a certain degree of slippage is obtained against the web of elastic material when this is fed against the mating roll, whilst at the same time the surface has sufficient retaining capacity for the cut-off elastic elements, then the gripping roll can be excluded. This then means that the underlying material web 7 is arranged adjoining the mating roll instead of the gripping roll. The elongation of the elastic elements is here obtained by utilising a higher speed in the material web than in the mating roll.

As has been stated above, the invention can be utilized in connection with the production of an absorbent product such as a sanitary towel, a panty liner, an incontinence pad or a nappy. To be precise, the invention is here utilized to apply the above-stated elastic elements in the production of the said absorbent products. In a manner which is essentially previously known, this type of absorbent product is made up of a plurality of layers, expediently comprising a first layer in the form of a surface layer, a second layer in the form of a back layer and a third layer in the form of an intermediate absorbent layer.

The back layer is preferably liquid-barring and expediently then consists of a liquid-impermeable material. Thin, liquid-tight plastics films are suitable for this purpose, but it is also possible to use materials which are liquid-permeable from the start, but which have been provided with a coating of plastic, resin, or some other liquid-tight material. Leakage of liquid from the underside of the absorbent product is thereby prevented. The back layer can thus consist of whatever material meets the liquid-impermeability criterion and is sufficiently flexible and kind to the skin for this purpose. Examples of materials which are suitable as the back layer are plastics films, nonwovens and laminates thereof. The plastics film can, for example, be made of polyethylene, polypropylene or polyester.

The back layer can alternatively consist of a laminate of a plastics layer, facing the absorption body, and a nonwoven, facing the underclothes of the user. Such a construction gives a leakproof back layer with a textile feel. The back layer can also be constituted by a steam-permeable material. A breathable back layer of this kind can be made, for example, of a so-called SMS-material (spunbond-meltblown-spunbond) or a breathable plastics film consisting of polyethylene. Such a plastics film is described in EP 283 200. In order to preserve the breathability even when the material has been applied to an article, the underside of the absorbent product should not be wholly covered by fastening means. Other conventional breathable materials, too, can also be utilized as the back layer.

The surface layer of the absorbent product can be made of any conventional material whatsoever, for example nonwoven, perforated plastics film or a laminate of a perforated plastics film and a nonwoven material. The surface layer is therefore expediently configured with liquid-permeable properties.

The absorption body of the absorbent product is expediently made of one or more layers of cellulose pulp. The pulp can originally exist in rolls, bales or sheets, which, in the production of the product, are dry-defibred and transferred in fluffed form to a pulp mat, sometimes with the admixture of so-called superabsorbents, which are polymers with the capacity to absorb many times their own weight in water or body fluid. An alternative to this is to dry-form a pulp mat as described in WO 94/10956. Examples of other usable absorption materials are various types of natural fibres, such as cotton wool fibres, peat, or the like. It is also possible, of course, to utilize absorbent synthetic fibres, or particles of a high-absorbent polymeric material of the type which, in case of absorption, chemically binds large quantities of liquid, forming a liquid-containing gel, or mixtures of natural fibres and synthetic fibres. The absorption body can further contain additional components, such as form-stabilizing members, liquid-spreading members, or binding agents such as, for example, thermoplastic fibres which have been heat-treated in order to hold together short fibres and particles into a cohesive unit. It is also possible to use in the absorption body various types of absorbent foam materials.

For fastening of the absorbent product, a fastening means can be attached to the underside of the absorbent product. This can be expedient where the absorbent product is constituted by, for example, a sanitary towel, a panty liner or an incontinence pad. The fastening means preferably consists of glue, but it can also be a mechanical fastening, such as, for example, VELCRO® fastenings, snap fasteners, friction lining, clamping members or the like. The glue can be applied in one or more strands or in some other pattern. Alternatively, the whole of the underside of the absorbent product is glue-coated. It is also possible to use a fastening glue which is breathable and to apply it over the whole of the underside of the product so that it acts as a combined barrier layer and fastening means. Attached to the fastening means is a protective layer. The protective layer is preferably a siliconized paper, but other variants of protective layers are also, of course, possible, for example waxed paper, embossed or release-agent-treated plastics film, textile strips for fixing to VELCRO® fastenings, etc.

According to the invention, an arrangement and a method for applying elastic elements on absorbent elements are provided, to be precise in those cases in which an elongation and application of such elastic elements are carried out during a production process for the said absorbent products. This has also been explained above with reference to FIG. 2.

The invention is not limited to the embodiments described above but can be varied within the scope of the following patent claims. For example, various types of elastic elements can be utilized, for example wires, bands, strips or the like, made of suitable ductile materials such as foam material. The material web which has been described can be made of nonwoven material, but other materials can also be considered, for example plastics films made of polyethylene, polypropylene or polyester. Alternatively, a material web made of laminated material can be used within the scope of the invention.

Although only preferred embodiments are specifically illustrated and described herein, it will be appreciated that many modifications and variations of the present invention are possible in light of the above teachings and within the purview of the appended claims without departing from the spirit and intended scope of the invention.

1. A method for applying elastic elements to a continuous material web, the method comprising:
advancing the elastic elements in series one after the other at a first predetermined speed to a nip formed between a first roll device and an abutment surface, wherein the abutment surface is arranged at a distance from the first roll device which is less than a combined thickness of the elastic elements and the material web,
advancing the material web at a second predetermined speed to the nip, wherein the second speed exceeds the first speed, and
attaching the elastic elements to the material web at the nip so as to elongate the elastic elements in their longitudinal direction as the elastic elements pass through the nip.

2. The method according to claim 1, wherein the method further comprises application of glue to the material web prior to the application of the elastic elements.

3. The method according to claim 1, wherein the method further comprises cutting of a continuous web of elastic material into the elastic elements.

4. The method according to claim 2, wherein the method further comprises cutting of a continuous web of elastic material into the elastic elements.

5. The method according to claim 1, wherein the abutment surface is defined by a peripheral surface of a second roll, and the material web is guided together with the said elastic elements between the first roll device and the said second roll as the said elastic elements are applied.

6. The method according to claim 1, wherein the abutment surface is defined by a surface of an ultrasonic horn, which is facing the first roll and is arranged to join together the elastic elements and the material web.

7. The method according to claim 6, wherein the ultrasonic horn is rotating.

8. The method according to claim 1, further comprising producing a holding effect for the respective elastic elements along a peripheral surface of the first roll device.

9. The method according to claim 8, wherein the holding effect is created by a vacuum device.

10. The method according to claim 8, wherein the holding effect is created by a coating on a peripheral surface of the first roll device, which coating has sufficiently high friction for the elastic elements to be held as they are advanced by means of the first roll device.

11. The method according to claim 1, wherein the first roll device comprises a mutually adjoining mating roll and gripping roll, the respective elastic element first being advanced on the said mating roll and then on the gripping roll.

12. The method according to claim 11, wherein the mating roll is driven at a speed which is lower than the speed of the gripping roll.

13. The method according to claim 1, further comprising cutting a continuous web of elastic material into the elastic elements.

14. The method according to claim 13, wherein the cutting device comprises a cutting roll adjoining the first roll device.

15. A method for applying elastic elements to a continuous material web, the method comprising:
advancing the elastic elements in series one after the other and at a first predetermined speed with a first roll, wherein an abutment surface is arranged at a distance from the first roll so as to form a nip defined by the first roll and the abutment surface; and
advancing the elastic elements at the first predetermined speed to the nip;
advancing the material web at a second predetermined speed to the nip, wherein the second speed exceeds the first speed; and
attaching the elastic elements to the material web at the nip.

16. The method according to claim 15, wherein the method further comprises application of glue to the material web prior to the application of the elastic elements.

17. The method according to claim 15, wherein the method further comprises cutting of a continuous web of elastic material into the elastic elements.

18. The method according to claim 16, wherein the method further comprises cutting of a continuous web of elastic material into the elastic elements.

19. The method according to claim 15, wherein the abutment surface is defined by a peripheral surface of a second roll, and the material web is guided together with the said elastic elements between the first roll and the said second roll as the said elastic elements are applied.

20. The method according to claim 15, wherein the abutment surface is defined by a surface of an ultrasonic horn, which is facing the first roll and is arranged to join together the elastic elements and the material web.

21. The method according to claim 15, further comprising producing a holding effect for the respective elastic elements along a peripheral surface of the first roll.

22. The method according to claim 21, wherein the holding effect is created by a vacuum device.

23. The method according to claim 21, wherein the holding effect is created by a coating on a peripheral surface of the first roll, which coating has sufficiently high friction for the elastic elements to be held as they are advanced by means of the first roll.
